(19) United States
(12) Patent Application Publication
(10) Pub. No.: US 2013/0146094 A1
(43) Pub. Date: Jun. 13, 2013

(54) CLEANING CARTRIDGE FOR A HEATING APPARATUS FOR COOKING FOOD AND MECHANISM FOR OPENING CARTRIDGE

(71) Applicant: Convotherm Elektrogeraete GmbH, Eglfing (DE)

(72) Inventors: Lutz Riefenstein, Weilheim (DE); Hannes Laessig, Muenchen (DE)

(73) Assignee: CONVOTHERM ELEKTROGERAETE GMBH, Eglfing (DE)

(21) Appl. No.: 13/712,506

(22) Filed: Dec. 12, 2012

Related U.S. Application Data
(60) Provisional application No. 61/570,077, filed on Dec. 13, 2011.

(51) Int. Cl. B08B 3/04

(52) U.S. Cl. CPC B08B 3/04
USPC 134/22.1; 134/105

(57) ABSTRACT

A cleaning agent/rinsing agent for cleaning a heating apparatus for cooking food are contained in a cartridge. The cartridge is sealed to prevent premature release of the cleaning/rinsing agents. Inside the cavity of the heating apparatus, a mechanism for opening the cartridge is located in the drain of the cavity of the heating apparatus. By pushing the cartridge onto the mechanism and twisting the cartridge, protruding edges of the mechanism penetrate the seal. Upon lifting the cartridge, the cleaning/rinsing agent drops out and into the cavity drain. The rinsing agent may be retained above the drain and cleaning box via encapsulation or the rinsing agent and configuration of the mechanism. The empty cartridge is removed and the cavity of the heating apparatus is ready for cleaning.

### FIELD OF THE INVENTION

This invention relates to a cleaning cartridge for cleaning an apparatus for the heat treatment and/or cooking of substances, in particular foods, which cartridge contains one or more cleaning agents(s) and one or more rinsing agent(s). The invention also relates to a novel mechanism for opening the cleaning cartridge inside the apparatus in a manner such that the operator has minimal risk of coming into contact with the chemicals released from the cartridge.

### DESCRIPTION OF THE BACKGROUND ART

A heating apparatus for the cooking of foods as described in U.S. Patent Publication No. US2004/0256374 shows the general configuration of the apparatus to which this invention is directed. In such prior art heating apparatuses, the cleaning of the heating device requires aggressive chemicals due to the heavy soiling with fats and proteins during the course of food processing. These aggressive chemicals present potential hazards to the operator of the apparatus due to the risk of direct contact with the chemicals and, in particular, with the cleaning agent during the dosing step. Different approaches have been tried in order to eliminate or reduce these hazards.

In GB 000002355246B4, powdery detergents are taught to be delivered though the use of dissolvable sachets. Those sachets can be placed inside the cavity of the heating apparatus, and they dissolve when coming into contact with water to release the cleaning detergent. However, the sachets tend to embrittle over time and may cause the untimely release of the detergent which can cause harm to the operator, or expensive cleanup of these hazardous materials.

In DE000010060204B4, there is proposed an alternative technology. Therein, powdery detergent is loaded into plastic cartridges and sealed with a wax cover. The cartridge is fixed upside down in the cavity of the heating device for cleaning. The heating device is then heated to melt the wax cover and release the detergent. Once the wax cover is heated and melted, the detergent drops out of the cartridge and is used for cleaning. DE00001006020B4 also discloses that a second cartridge containing rinse agent is disposed in a manner similar to the detergent cleaning cartridge, and is configured/constructed so that the rinse agent is released at the appropriate time in the cleaning cycle. An alternative embodiment disclosed in DE00001006020B4 is for the cleaning agent and rinsing agent to be in the same cartridge, directly in contact with each other and with cleaning agent directly in contact first with the water used for cleaning. The cleaning agent is dissolved first by the water and, as it dissolves, the rinse agent gradually moves downward until it comes in contact with the water and commences the rinsing step. A disadvantage of this prior art cleaning system is that, in the case of dual cartridges being used, the cartridges may not completely dissolve during the cleaning cycle, leaving open the possibility that the operator may still come in contact with some of the cleaning/rinsing chemicals when the cartridges are removed for use of the heating apparatus, or that undissolved cartridge material may be left behind and potentially damage the heating apparatus or contaminate the food when the apparatus is placed back into use for cooking foods. Also, the dual cartridges require increased storage space. Another disadvantage of this cleaning system is that, in the single cartridge embodiment, the cartridge must be made undissovable so that the rinsing agent does not come in contact with the water until the cleaning agent is fully dispensed, again raising the possibility of the problems of (1) contact by the operator who must reach into the apparatus at the end of the cleaning cycle to retrieve the cartridge and (2) all or part of the cartridge being left behind in the heating apparatus because of breakage or because its removal was incomplete. Also, in the alternative embodiment, the cleaning agent and rinsing agent must be compatible and unreactive toward each other because they are in direct contact with each other in the cartridge.

Also known in the art are cleaning cartridges which contain both a cleaning agent in powder form and rinsing agent embedded in the cleaning agent but protected from the cleaning agent in a waxy substance. However, in this product, the cartridges are sealed with foil which must be removed prior to insertion into the heating apparatus, leading to possible danger of exposure to the operator from the chemicals in the cartridge, as well as from the removed foil seal.

### OBJECTS OF THE INVENTION

It is an object to this invention to provide a cleaning agent/rinsing agent system which does not have to be opened prior to being introduced into the heating device.

It is also an object of this invention to provide a cleaning/rinsing agent system which removes any possibility of contamination or danger to the operator of the heating apparatus from the cleaning/rinsing agents.

It is a further object of this invention to provide a novel mechanism for opening of the cleaning/rinsing agent system only after that system is introduced into the heating apparatus.

It is a still further object of this invention to provide a method of cleaning a heating apparatus using the cleaning/rinsing agent cartridges and the opening mechanism of the present invention.

### SUMMARY OF THE INVENTION

These and other objects are met through applicants' present invention wherein a cleaning agent/rinsing agent system for cleaning a heating apparatus for cooking food is contained in a cartridge. The cleaning agent and rinsing agent may be contained in the same portion of a single cartridge, or in separate portions of a single cartridge, or in separate cartridges. The following description will discuss the single cartridge system, but a separate cartridge system will be apparent from the following description. The system comprises at least one cleaning agent and at least one rinsing agent which are separated from one another in the cartridge by a barrier material surrounding or encapsulating the rinsing agent, and the cartridge is sealed in a manner to prevent premature release of the cleaning agent and rinsing agent, yet in a manner that allows for the cleaning agent and rinsing agent to be released only after introduction into the heating apparatus. The cartridge according to the present invention is not opened outside of the heating apparatus, does not remain in the heating apparatus during the cleaning cycle, and is removed by the operator before the cleaning cycle begins. This provides safety for both the operator and the apparatus.

The invention will be described in more detail hereinafter with reference to a specific exemplary embodiment and reference to the accompanying drawings.

### BRIEF DESCRIPTION OF THE DRAWINGS

Further details, features and advantages of this invention result from the following description of an embodiment using the drawings in which

FIG. 1 shows a schematic drawings of the type of heating apparatuses which are generally serviced by the cleaning system of the present invention.

FIGS. 2 (a) and (b) show a schematic drawing of two embodiments of a single dose cartridge of the present invention;

FIG. 3 shows an overhead perspective view of the mechanism of the present invention for opening a cartridge such as are shown in FIG. 2;

FIGS. 4, 5 and 6 show stepwise use of the single dose cartridge such as in FIG. 2 using the mechanism for opening such as in FIG. 3;

FIGS. 7 (a) and (b) show alternative embodiments of the mechanism for opening cartridges such as are shown in FIG. 2; and

FIG. 8 shows a schematic drawing of an alternative embodiment of a cleaning cartridge of the present invention.

### DETAILED DESCRIPTION OF THE PREFERRED EMBODIMENTS

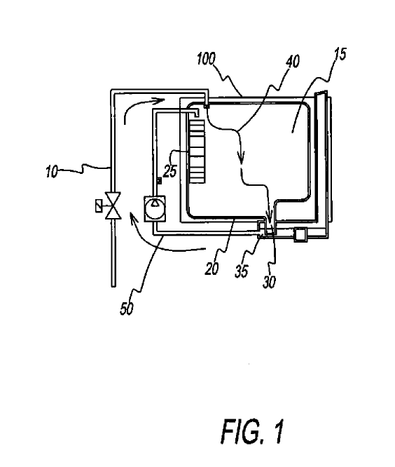

FIG. 1 is a type of apparatus referred to generally as a “circulation system” in which water for cleaning is circulated from a drain in the floor of the apparatus up and to a circulating fan inside the oven. In FIG. 1, feed line (10) serves to bring water for cleaning to the heating apparatus (100) and is disposed through the upper portion of heating apparatus (100) in at least one location. Water flows through feed line (10) and into the heating apparatus (100). Heating apparatus has a cavity (15) with a bottom (20) and disposed in the bottom (20) is a drain (30) leading to a cleaning box (35). Water flows in the general direction of the arrows (40). In FIG. 1, a circulating line (50) returns water from the drain (30) and cleaning box (35) to the cavity (15). The water is spread though the cavity to effect thorough cleaning by a fan (25).

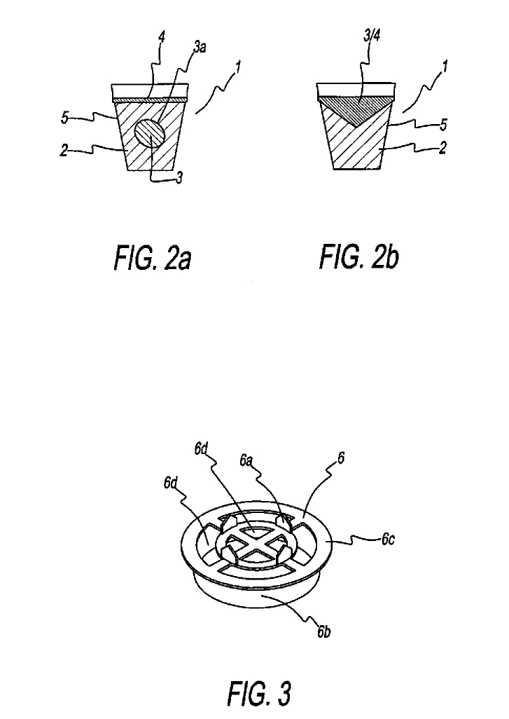

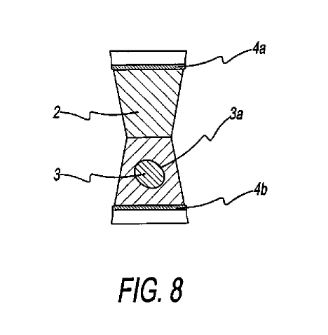

Referring to FIG. 2 (a), a single dose of cleaning/rinsing agent (1) is disposed within a cartridge (5). The cleaning agent (2) is contained within the cartridge along with a rinsing agent (3). The rinsing agent (3) is separated from the cleaning agent (2) with a barrier material (3a). The single dose of cleaning/rinsing agent is retained in the cartridge (5) with a sealing material (4). Referring to FIG. 2 (b), the configuration of the cartridge is somewhat different, wherein the cleaning agent (2) is in the cartridge, and the rinsing agent (3) is contained in the sealing material (4). Referring to FIG. 8, the configuration of the cartridge is again somewhat different, wherein the cleaning agent (2) is in one chamber of the cartridge and the rinsing agent (3) is in another chamber of the cartridge. Sealing materials (4a) and (4b) may be the same or different, depending upon the cleaning agent and rinsing agent used. The applications of these different embodiments will be explained in more detail, below.

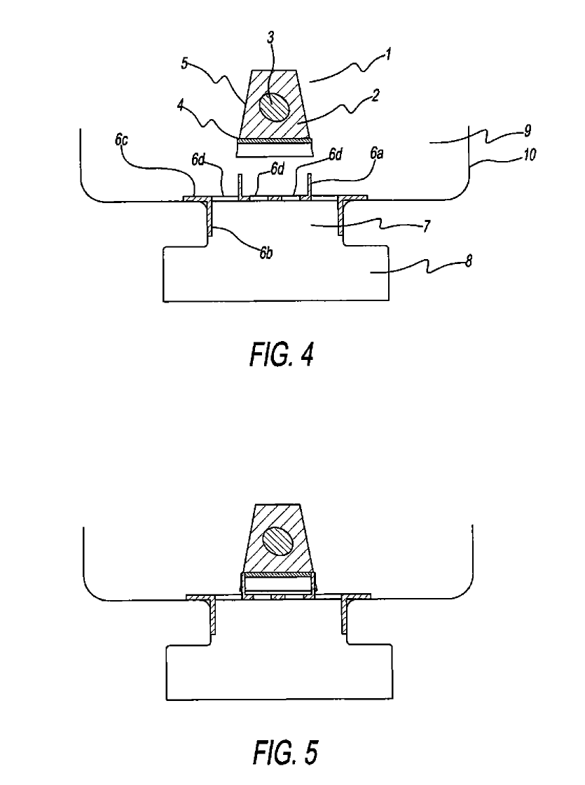

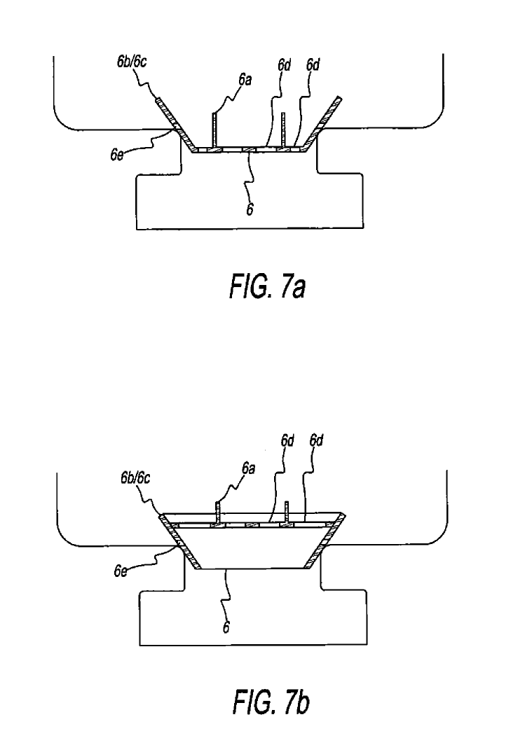

Referring to FIGS. 3, and 7 (a) and (b), the mechanism (6) for opening the cartridge (5) and releasing the single dose of cleaning/rinsing agent (1) is shown. In FIG. 3, the mechanism for opening the cartridge includes protruding edges (6a), a neck portion (6b) for fitting into the drain (30) of the heating apparatus, a flange (6c) for supporting the mechanism (6) on the bottom (20) of the heating apparatus and for preventing the mechanism from dropping into the cleaning box (35) located under the drain (30) and a plurality of apertures (6d). In FIGS. 7 (a) and (b), like numerals refer to like parts of the mechanism (6) for opening. In FIGS. 7 (a) and (b), the neck portion (6b) and flange (6c) have been replaced by a tapered portion (denoted ‘6b/6c” in FIGS. 7 (a) and (b) to indicate that the tapered portion performs the function of both the neck portion and flange). Also in FIGS. 7 (a) and (b), there are added additional apertures (6e) for aiding in the flow of cleaning agent solution and rinsing agent solution from the cavity (15) through the bottom (20) and into the drain (30) and cleaning box (35) of the heating apparatus.

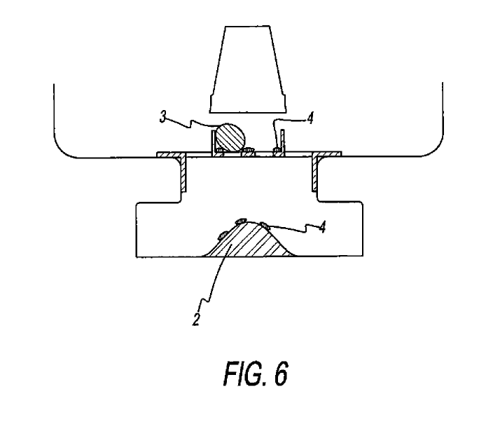

Referring to FIGS. 4, 5 and 6, FIG. 4 shows the single dose cleaning/rinsing agent-containing cartridge (5) positioned above the mechanism (6) for opening the cartridge (5) immediately prior to use. FIG. 5 shows the rinsing/cleaning agent-containing cartridge (5) engaged in place for opening upon the mechanism (6) with the protruding edges (6a) engaged with the sealing material (4). FIG. 6 shows the single dose cleaning/rinsing agent (1) released from the cartridge (5), with the single dose of cleaning agent (2) and remnants of the sealing material (4) having fallen into the cleaning box (35) and with the single dose of rinsing agent (3) being retained above the cleaning box (35) due to the size and configuration of the apertures (6d).

### DETAILED DESCRIPTION OF THE INVENTION

The following detailed description is made in accordance with the single dose cleaning/rinsing agent-cartridge combination depicted in FIGS. 2 (a) and (b), and 8.

The cleaning agent (2) used in the present invention can be any suitable cleaning agent for heating apparatuses known to those skilled in the art. Because it is retained in the cartridge by the sealing material, the cleaning agent can be powder or liquid. The embodiments of FIGS. 2 (b) and 8 may be useful when the cleaning agent and the rinsing agent are in forms or of substances which render their inclusion or release from the cartridge of the type in FIG. 2 (a) perhaps not ideal. In the embodiments of FIG. 2 (a) or FIG. 8, it is envisioned that the cleaning agent is in liquid form, although this is not required. These embodiments will been further explained below. Whether it is liquid or powder, there are certain useful parameters for the cleaning agent. First, the cleaning agent should be inert toward the cartridge material itself, i.e. the cleaning material should not degrade nor dissolve the cartridge material at a substantially fast rate. Second, the cleaning agent should be inert toward the sealing material as well, so that is does not compromise the integrity of the sealing action of the sealing material to a substantial degree, and so that the cleaning/rinsing agents do not leak from the cartridge. Third, the cleaning agent should be inert toward the barrier material surrounding or encapsulating the rinsing agent so that the integrity of the barrier material is also not compromised to any meaningful degree and the rinsing agent it thus not released prematurely during the cleaning cycle for the heating apparatus. Preferably, the cleaning agent is in powder or granular form, and more preferably the cleaning agent is comprised of one or more alkaline cleaning powders. Among the alkaline powders known in the art are NaOH and KOH; these may have included additives which are commonly used and known to those skilled in the art.

As with the cleaning agent, the rinsing agent (3) used in the present invention also can be any suitable rising agent for heating apparatuses known to those skilled in the art. Again, as with the cleaning agent, the rinsing agent can be either a powder or liquid. The rinsing agent itself does not need to have all the useful parameters attributed to the cleaning agent. The rinsing agent is unlikely to come in contact with the cartridge material (unless it is in the form as shown in FIG. 2 (b)) or with the cleaning agent because of the barrier material. All that is useful for rinsing agent is that, if liquid, it does not permeate or dissolve the barrier material and, if powder or granular, is retained in and is essentially non-reactive toward the barrier material. Preferably, the rinsing agent is in powder or granular form and has some surface reducing properties to aid in rinsing, and more preferably the cleaning agent is comprised of one or more acidic rinsing agents. Among the rinsing agents known in the art are citric acid and phosphoric acid; these may have included additives which are commonly used and known to those skilled in the art.

The barrier material (3a) surrounding or encapsulating the rinsing agent can be made of any material suitable to retain the rinsing agent and maintain its integrity while in contact with the cleaning agent and rinsing agent. Also, the barrier material must be resistant to water and to the solution of cleaning agent in water so that it remains intact and resting on the apertures of the mechanism for opening the cartridge during the cleaning cycle. Finally, the barrier material must be resistant to the elevated temperatures used during the cleaning step of the cleaning cycle. At the same time, the barrier material must be capable of being dissolved or melted at the appropriate time during the cleaning cycle, i.e. after the cleaning solution is removed from the heating apparatus. By way of illustration, the barrier material can be made of water-insoluble polymer, rubbery material or wax, so long as it meets the above desirable properties of stability toward the cleaning agent and rinsing agent, and of temperature resistance. In practice when the rinsing agent is granular, the rinsing agent may be mixed with the barrier material (e.g. wax at elevated temperature), and then cooled to any shape or form desired. This can be accomplished by forming the encapsulated rinsing agent after it is cooled or by placing the liquid wax-encapsulated rinsing agent in molds of desired size and shape. Preferably, the barrier material is a wax block which encapsulates the rinsing agent. Also preferably, the barrier material releases the rinsing agent through the use of elevated temperature inside the heating apparatus once the cleaning step of the cleaning cycle is complete. In an alternative preferred embodiment, and particularly when the rinsing agent is liquid, but not limited to when the rinsing agent is liquid, the barrier material can be a layer which surrounds the rinsing agent in a balloon-like manner. Again, in this embodiment, the barrier layer will have the same characteristics as desired of the barrier material.

The sealing material (4) which encloses the cleaning agent and rinsing agent in the cartridge can also be any material which meets certain desirable physical and chemical properties, and can be chosen according to the particular cleaning/rinsing agent-cartridge combinations. First, the sealing material should have sufficient strength to resist cracking or breaking when the single dose cleaning/rinsing agent cartridges are stacked upon one another or dropped, either in shipping or in storage. Second, the sealing material should be capable of promoting and maintaining an integral seal with the cartridge material so that the cleaning agent does not prematurely exit from the cartridge, whether the cleaning agent is in solid or liquid form. Third, the sealing material should be resistant to attack from the cleaning agent so that it does not degrade from contact with the cleaning agent prematurely. Of course, some degradation can be acceptable in certain cases over time, and the sealing material can be made to a sufficient thickness to withstand that degradation. Fourth, the sealing material should usually be sensitive to either water and/or heat so that it can be substantially removed from the heating apparatus at the end of the cleaning and rinsing cycle and does not remain behind to interfere with subsequent use of the heating apparatus. However, in the embodiment of FIG. 8, this is not necessary. In the embodiment of FIG. 8, the cleaning agent may be liquid. In this case, the sealing material retaining the cleaning agent may be made of any material that can be pierced by the protruding edges of the opening mechanism to release the liquid; in this case, the sealing material can remain attached to the cartridge and removed from the heating apparatus by the operator when the cartridge is removed. Finally, the sealing material should be easily pierced by the protruding edges of the mechanism so that the cleaning/rinsing agent is dispensed easily and substantially completely into the heating apparatus. As long as it satisfies these parameters, the sealing material can be made from any suitable material, including cellulosic polymers, water soluble polymers, waxes and the like. Preferably, the sealing material is a wax layer. In the embodiment of FIG. 2 (b), the rinsing agent is incorporated into the sealing material. In the embodiment of FIG. 8, the cleaning agent and rinsing are contained in separate chambers of the cartridge, and the same or different sealing material may be used as (4a) and (4b).

The material comprising the cartridge (5) holding the single dose cleaning/rinsing agent is not of critical importance because the cartridge is not involved in the actual cleaning cycle nor in contact with the cleaning agent solution, nor left in the heating apparatus during the cleaning cycle. However, the cartridge should have sufficient strength to withstand packaging and storage environments, and should be resistant to the chemical nature of the cleaning agent itself. Likewise, it should have some adhesion acceptance to the sealing material so that an integral seal between it and the sealing material is maintained. Finally, the cartridge material should be of such a nature that it allows the cleaning agent and rinsing agent to fall freely from it and retain little or none of those agents.

The following detailed description is made in accordance with the mechanism depicted in FIG. 3.

The mechanism (6) for opening the cartridge is of a design that meets the parameters of fitting into the drain while not falling into the drain box, while at the same time having one or more protruding edges for breaking the sealing material away from the cartridge and releasing the single dose cleaning/rinsing agent into the heating apparatus accurately in relation to the drain and cleaning box. The mechanism can be made of any suitable material which is compatible with the temperatures inside the heating apparatus and also compatible with the chemical nature of the cleaning agent and rinsing agent solutions. The mechanism can be made of, e.g., plastic, metal, hard rubber or combinations thereof. Among those materials that can be used are PTFE, HDPE, UHMWPE, carbon black-filled PE, different types and grades of corrosion resistant metals, and the like. The preferred material for the mechanism is stainless steel. The mechanism also has a surface disposed within the periphery of the neck which surface may be positioned anywhere within the neck so long as there are present apertures, described below, which prevent the encapsulated rinsing agent from falling through the drain and into the cleaning box prior to the rinse step of the cleaning cycle. As mentioned, the mechanism has one or more protruding edges protruding away from the surface of the mechanism toward the interior cavity of the heating apparatus. The protruding edge(s) are preferably substantially perpendicular, but need not be perpendicular, and can be attenuated away from perpendicular in either an acute or obtuse angle to some degree as the case may be. To aid in the ease of breaking the sealing material and releasing the single dose cleaning/rinsing agent, the protruding edge(s) preferably should be spaced apart so that all of the protruding edge(s) fit within the inner edge of the cartridge container, although this is not necessary in all applications. It is sufficient if the protruding edge(s) are capable of breaking the sealing material and releasing the cleaning agent and rinsing agent in the appropriate location above and into the drain and cleaning box. There may be one or more protruding edge(s) and, in the case of one protruding edge, this can be a single continuous edge of such a geometry that it fits the interior opening of the cartridge or it may be, on the other end of the spectrum, a single needle-like or blade-like protrusion about which the cartridge is rotated so as to break the sealing material and release the single dose cleaning/rinsing agent. In the case of opening a cartridge such as embodied in FIG. 2 (b), where the rinsing agent in incorporated into the sealing material, it may be advantageous to have the protruding edge be one continuous edge so that the rinsing agent/sealing material composite is released in more or less one piece, to reduce or eliminate the likelihood that the rinsing agent will be prematurely released into the heating apparatus cavity. In the case of a plurality of protruding edge(s), these may be of any nominal geometry (in FIG. 3 depicted as a series of four concentrically arranged pentagonal protrusions) about which the cartridge is rotated to break the sealing material and release the single dose cleaning/rinsing agent. The protruding edge(s) also should be of a length sufficient to substantially penetrate the thickness of the sealing material, but not so long that the protruding edge(s) come into substantial contact with the walls of the cartridge on the cleaning agent side of the sealing material. This ensures that the walls of the cartridge are not punctured by the protruding edge(s), and reduces the risk that the operator may come into contact with the cleaning agent. In the case of opening a cartridge such as in the embodiment of FIG. 8, wherein the cleaning agent is liquid, it is sufficient that the protruding edges pierce the sealing material (4a) to allow the cleaning agent to exit the cartridge. In this case, the sealing material retaining the cleaning agent, as mentioned above, can be of any material (even one that is insoluble in water, as is usually desirable) because the sealing material does not enter and remain in the cavity of the heating device. The neck portion of the mechanism can be of any length so long as it is of sufficient length to maintain alignment of the mechanism in the drain and over the cleaning box. Likewise, the flange of the mechanism can be of any design so long as it is of sufficient size to prevent the mechanism itself from falling, and the encapsulated rinsing agent from falling prematurely, into the drain and cleaning box (in FIG. 3 the flange is depicted as an integral one piece flange around the periphery of the mechanism). It can be envisioned that the flange could also be a series of spaced pieces protruding substantially parallel to the surface of the mechanism so as to rest upon and/or otherwise engage the bottom of the heating apparatus cavity. All such embodiments of the term flange are included in the definition of flange as used herein. In another embodiment, such as schematically shown in FIGS. 7 (a) and (b), there may be no flange at all, but the neck of the mechanism may be configured in such a manner to engage substantially completely the drain opening, and angled in such a manner so that a portion of the neck passes through the bottom of the cavity, and partially into the drain, while another portion of the neck remains disposed above the bottom of the cavity, thus effectively preventing the mechanism from falling into the drain. In these arrangements, it is beneficial to include along the outer periphery of the neck, near or just above the bottom of the cavity, another series of apertures (6e) to allow draining of the cleaning agent/water solution and of the rinsing agent/water solution from the apparatus.

Also as part of the mechanism for opening, there are provided a series of apertures disposed in the surface of the mechanism. In the case where the surface of the mechanism is neither disposed above nor below the neck of the mechanism, it is sufficient if the apertures are disposed in the surface of the mechanism. In the case where the surface is disposed above or below the surface of the mechanism, the apertures may be disposed only in the surface of the mechanism, or in the surface and in the neck portion below the surface or above the surface as the case may be. In any event, the apertures are of sufficiently large size and number to allow the cleaning agent to pass through the mechanism for mixing with water to make the cleaning agent solution in the cleaning box, but of sufficiently small size to retain the encapsulated rinsing agent away from the drain and cleaning box until it is desirable for the encapsulated rinsing agent enter the drain and cleaning box for the rinse cycle. In any event, the apertures in the surface, regardless of where the surface is disposed, should be of sufficient size and number to allow the cleaning agent to pass through the surface of the mechanism and into the drain and cleaning box when the operator opens the cartridge with the mechanism so as to minimize the possibility that the operator comes into contact with the cleaning agent when opening the cartridge.

The following detailed description of the manner in which the invention is practiced in the following manner is made in accordance with the operation of the cleaning procedure, as schematically depicted ins FIGS. 4, 5 and 6. Other manners of practicing the cleaning procedure using other embodiments of the present invention will be apparent to those skilled in the art.

The operator of the heating apparatus activates the automatic cleaning system of the apparatus. The operator then opens the door to the heating device to permit entry into the cavity. The operator removes a cartridge containing the single dose cleaning/rinsing agent from storage. The wax seal prevents contact by the operator with the cleaning agent. The cartridge is inverted over the mechanism for opening and pushed down upon it, causing the protruding edge(s) to contact and pierce the wax seal at one or more points around the periphery of the inner wall of the cartridge. To the extent necessary, the operator rotates the cartridge about the protruding edge(s) to break the adhesion between the wax seal and the inner walls of the cartridge, and then lifts the cartridge away from the mechanism. The cleaning agent and broken pieces of the wax seal drop through the mechanism and drain and into the cleaning box, where the cleaning agent is dissolved in water. The wax block containing the rinsing agent preferably remains on the surface of the mechanism due to the configuration of the apertures, and rests there. The cleaning portion of the cleaning/rinsing cycle is initiated and conducted at a temperature below the melting temperature of the wax block. At the end of the cleaning portion of the cleaning/rinsing cycle, the cleaning fluid is removed from the heating apparatus. The temperature inside the cavity of the apparatus is increased and the wax block melts, releasing the rinsing agent. The rinsing agent drops down the drain and into the cleaning box and is then used in the rinse cycle. Thereafter, the rinse fluid is removed, and the heating apparatus is flushed as desired with water until the apparatus is clean and ready for further operation.

By way of alternate example, when using a single dose cartridge as embodied in FIG. 8, the operator will remove the cartridge from its storage container and expose the sealing materials of each chamber as the case may be. The operator places the seal of the chamber containing the cleaning agent on the mechanism for opening, punctures the sealing material (in the case where the cleaning agent is liquid), and allows the cleaning agent to drain from the cartridge. Then the operator turns the cartridge over and breaks the seal on that chamber of the cartridge which contains the rinsing agent, thereby releasing the rinsing agent to be retained on the apertures of the mechanism for cleaning. The remaining steps of the cleaning procedure are unchanged.

The operator simply disposes of the cartridge in an appropriate manner, and at no time is at risk of contacting the cleaning agent. Also, because the cartridge does not leave the hand of the operator, and is instantly removed as soon as the single dose cleaning/rinsing agent is released, there is no danger that the cartridge can be forgotten or left behind and cause damage to the heating apparatus and/or contamination of the food later cooked in the apparatus.

Other embodiments of the present invention will be evident to those of skill in the art based upon applicants' present disclosure. For example, the cleaning agent and rinsing agent may be in separate portions of the same cartridge, or in separate cartridges, although this latter instance may not be preferred because it increases steps for the operator. All such other embodiments are intended to fall within the scope if this invention and of the appended claims.

All of the patents and other publications referred to in this disclosure are herein incorporated by reference into this disclosure as if fully set forth herein.

What is claimed is:

1. A cleaning cartridge for cleaning an apparatus for the heat treatment and/or cooking of substances, said cartridge comprising:
at least one cleaning agent and at least one rinsing agent disposed within the same portion of the cartridge, and wherein the cleaning agent and the rinsing agent are separated from one another in the cartridge by a barrier material surrounding or encapsulating the rinsing agent, and wherein the cartridge includes water soluble or heat sensitive seal to prevent premature release of the cleaning agent and rinsing agent from the cartridge.

2. The cleaning cartridge of claim 1, wherein the cleaning agent is selected from powder and liquid.

3. The cleaning cartridge of claim 1, wherein the cleaning agent is comprised of an alkaline cleaning agent.

4. The cleaning cartridge of claim 1, wherein the rinsing agent is selected from powder and liquid.

5. The cleaning cartridge of claim 1, wherein the rinsing agent is comprised of acidic rinsing agent.

6. The cleaning cartridge of claim 1, wherein the barrier material is selected from of water-insoluble polymer, rubbery material or wax.

7. The cleaning cartridge of claim 8, wherein the barrier material is comprised of wax.

8. The cleaning cartridge of claim 1, wherein the seal is comprised of cellulosic polymers, water soluble polymers or wax.

9. The cleaning cartridge of claim 8, wherein the seal is comprised of a wax layer.

10. A cleaning cartridge for cleaning an apparatus for the heat treatment and/or cooking of substances, said cartridge comprising:
at least one cleaning agent and at least one rinsing agent disposed within the cartridge and wherein the cleaning agent and the rinsing agent are separated from one another in the cartridge, and wherein the cartridge includes a seal to prevent premature release of the cleaning agent and rinsing agent from the cartridge, and wherein at least the seal preventing premature release of the rinsing agent is a water soluble or heat sensitive seal.

11. A cleaning cartridge system for cleaning an apparatus for the heat treatment and/or cooking of substances, said cartridge comprising:
at least one cleaning agent and at least one rinsing agent disposed within separate cartridges, and wherein the cartridge includes a seal to prevent premature release of the cleaning agent and rinsing agent from the cartridge and wherein at least the seal preventing premature release of the rinsing agent is a water soluble or heat sensitive seal.

12. A mechanism for opening a cleaning cartridge, said mechanism suitable for use in an apparatus for the heat treatment or cooking of substances, said apparatus including a cavity having a door disposed thereon which sealingly closes the cavity, said cavity having a back wall, a top wall, two side walls and a bottom, and having disposed in the bottom a drain and a cleaning box connected to the drain, said drain and cleaning box allowing for the ingress and egress of water for cleaning the apparatus, said mechanism comprising: (a) a neck portion fitting into the drain, (b) a flange portion disposed in a manner to prevent the mechanism from dropping into the cleaning box located under the drain, (c) a surface disposed within the geometry of the neck, said surface having a plurality of apertures of sufficient number and size to allow the cleaning agent disposed within the cartridge to pass through the apertures and into the drain, and (d) at least one protruding edge, said protruding edge disposed above the surface in a direction toward the interior of the cavity.

13. A mechanism for opening a cartridge, said mechanism suitable for use in an apparatus for the heat treatment or cooking of substances, said apparatus including a cavity having a door disposed on the front of the cavity which sealingly closes the cavity, said cavity having a back wall, a top wall, two side walls and a bottom, and having disposed in the bottom a drain and a cleaning box connected to the drain, said drain and cleaning box allowing for the ingress and egress of water for cleaning the apparatus, said mechanism comprising: (a) a neck portion fitting into the drain, said neck portion configured in such a manner to engage substantially completely the drain opening, and angled in such a manner so that a portion of the neck portion passes the through the bottom of the cavity and partially into the drain, while another portion of the neck remains disposed above the bottom of the cavity, thus effectively preventing the mechanism from falling into the drain, (b) a surface disposed within the geometry of the neck, said surface having a plurality of apertures of sufficient number and size to allow the cleaning agent disposed within the cartridge to pass through the apertures and into the drain, and (d) at least one protruding edge, said protruding edge disposed above the surface in a direction toward the interior of the cavity.

14. A method of cleaning an apparatus for the heat treatment or cooking of substances, said apparatus including a cavity having a door disposed on the front of the cavity which sealingly closes the cavity, said cavity having a back wall, a top wall, two side walls and a bottom, and having disposed in the bottom a drain and a cleaning box connected to the drain, said drain and cleaning box allowing for the ingress and egress of water for cleaning the apparatus, said method comprising: opening the door to the heating device to permit entry into the cavity; removing a cartridge containing a single dose cleaning/rinsing agent from storage; inverting the cartridge over a mechanism disposed in the drain; pushing down upon the cartridge causing protruding edge(s) on the mechanism to contact and pierce a seal on the inner wall of the cartridge and release the cleaning/rinsing agent; lifting the cartridge away from the mechanism; removing the cartridge from the cavity; closing the door; and starting the cleaning of the heating apparatus.
